(19) United States
(12) Patent Application Publication
(10) Pub. No.: US 2016/0187467 A1
(43) Pub. Date: Jun. 30, 2016

(54) AXLE DETECTION APPARATUS

(71) Applicant: KABUSHIKI KAISHA TOSHIBA, Tokyo (JP)

(72) Inventors: Toshio SATO, Yokohama Kanagawa (JP); Yasuhiro AOKI, Kawasaki Kanagawa (JP); Yusuke TAKAHASHI, Tama Tokyo (JP); Yasuhiro TAKEBAYASHI, Kamakura Kanagawa (JP); Hiroyuki KUWAGAKI, Kawasaki Kanagawa (JP); Nobuyuki SUEKI, Soka Saitama (JP)

(21) Appl. No.: 14/911,149

(22) PCT Filed: Jul. 24, 2014
(86) PCT No.: PCT/JP2014/069544

§ 371 Date: Feb. 9, 2016

(30) Foreign Application Priority Data
Aug. 23, 2013 (JP) 2013-173810

(51) Int. Cl. G01S 7/48; G01B 11/02; G01S 17/87

(52) U.S. Cl. CPC G01S 7/4802; G01S 17/87; G01B 11/026

(57) ABSTRACT

According to some embodiments of the present invention, an axis detection device includes a plurality of distance measurement devices; a tire candidate extractor; a matching processor; and an axle detector. Each of the plurality of distance measurement devices changes a measurement range to one dimension to measure a distance data set. The tire candidate extractor extracts data whose frequency is higher than a predetermined threshold as tire candidate data based on the distance data set measured by the distance measurement device. The matching processor matches a temporal correspondence for the tire candidate data which are extracted by the tire candidate extractor based on the respective distance data sets measured by the plurality of distance measurement devices. The axle detector detects one or a plurality of axles based on the matched result by the matching processor.

### CROSS-REFERENCE TO RELATED APPLICATIONS

This application is based upon and claims the benefit of priority from Japanese Patent Application No. 2013-173810, filed Aug. 23, 2013, the content of which is incorporated herein by reference.

### FIELD

Embodiments described herein relate generally to axle detection apparatuses.

### BACKGROUND

In toll booths on highways, etc., charges to be levied may differ depending on differences in the number of axles of vehicles (the number of tires). For example, in the toll booths which are not an ETC (electronic toll collection system), for example, it is necessary to identify the type of vehicles. The types of vehicles include ordinary vehicles and two-wheeled vehicles that are two-axle vehicles, large-size vehicles which are three-axle vehicles, and extra-large size vehicles which are four-axle vehicles.

Axle detection apparatuses have been considered which detect a tire of a vehicle to detect an axle of the vehicle.

### BRIEF DESCRIPTION OF THE DRAWINGS

FIG. 1 is a block diagram illustrating a configuration of an axle detection apparatus according to Embodiment 1;

FIG. 2 is an arrangement diagram (a front view) illustrating installations of laser scanners according to the Embodiment 1;

FIG. 3 is an arrangement diagram (a top view) illustrating installations of the laser scanners according to the Embodiment 1;

FIG. 4 is a schematic diagram illustrating an arrangement of installations of the laser scanners and exemplary scans according to the Embodiment 1;

FIG. 5 is a schematic diagram illustrating the operating principles of coordinate converters according to the Embodiment 1;

FIG. 6 is a diagram illustrating an example of measured results of distance measurement devices according to the Embodiment 1;

FIG. 7 is a schematic diagram illustrating a range of a region specified by measurement region setting devices according to the Embodiment 1;

FIG. 8 is a schematic diagram illustrating that tire and vehicle distances are measured by the laser scanners according to the Embodiment 1;

FIG. 9 is a schematic diagram illustrating a frequency distribution on results of measuring the tire and vehicle distances by the laser scanners according to the Embodiment 1;

FIG. 10 is a diagram illustrating the operating principles of distance histogram preparation devices according to the Embodiment 1;

FIGS. 11A-11C are schematic diagrams illustrating the operating principles of tire candidate extractors according to the Embodiment 1;

FIGS. 12A and 12B are schematic diagrams illustrating the operating principles of a left right matching processor according to the Embodiment 1;

FIG. 13 is a top view illustrating a reference plate which is laid on a road according to Embodiment 2; and

FIG. 14 is a block diagram illustrating a configuration of an axle detection apparatus according to Embodiment 3.

### DETAILED DESCRIPTION

According to some embodiments of the present invention, an axis detection device includes a plurality of distance measurement devices; a tire candidate extractor; a matching processor; and an axle detector. Each of the plurality of distance measurement devices changes a measurement range to one dimension to measure a distance data set. The tire candidate extractor extracts data whose frequency is higher than a predetermined threshold as tire candidate data based on the distance data set measured by the distance measurement device. The matching processor matches a temporal correspondence for the tire candidate data which are extracted by the tire candidate extractor based on the respective distance data sets measured by the plurality of distance measurement devices. The axle detector detects one or a plurality of axles based on the matched result by the matching processor.

### First Embodiment

Below, an axle detection apparatus 1 according to Embodiment 1 is described with reference to the drawings.

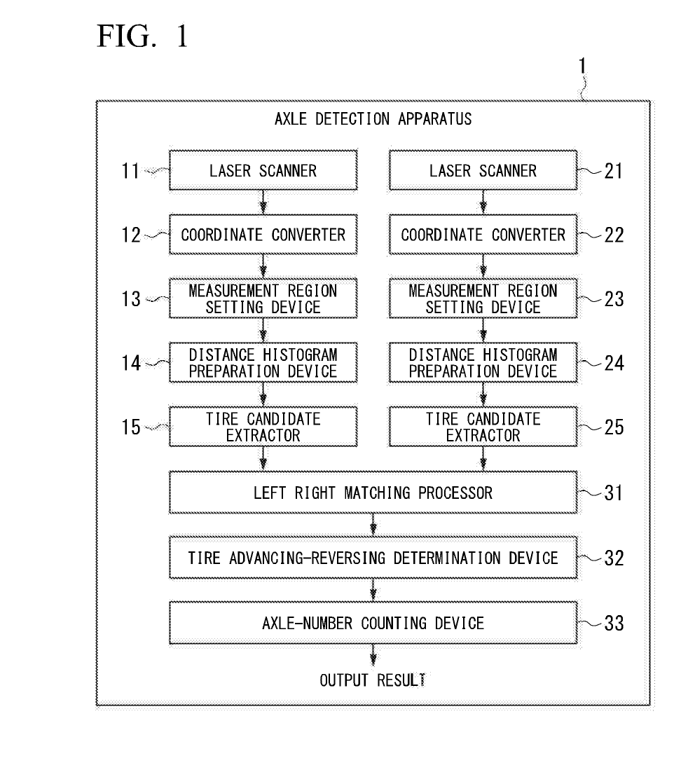

FIG. 1 is a block diagram illustrating a configuration of the axle detection apparatus 1 according to the Embodiment 1.

The axle detection apparatus 1 includes two-unit elements of two laser scanners 11 and 21; two coordinate converters 12 and 22; two measurement region setting devices 13 and 23; two distance histogram preparation devices 14 and 24; and two tire candidate extractors 15 and 25 and one-unit element of one left right matching processor 31; one tire advancing/reversing determination device 32; and one axle-number counting device 33.

Here, according to the present embodiment, the two-unit processing elements are provided in the respective sides of a vehicle, while the one-unit processing element is used in common by the respective sides of the vehicle. Those other than the laser scanners 11 and 21 can also be integrated into one common processing element to be processed in time division, etc.

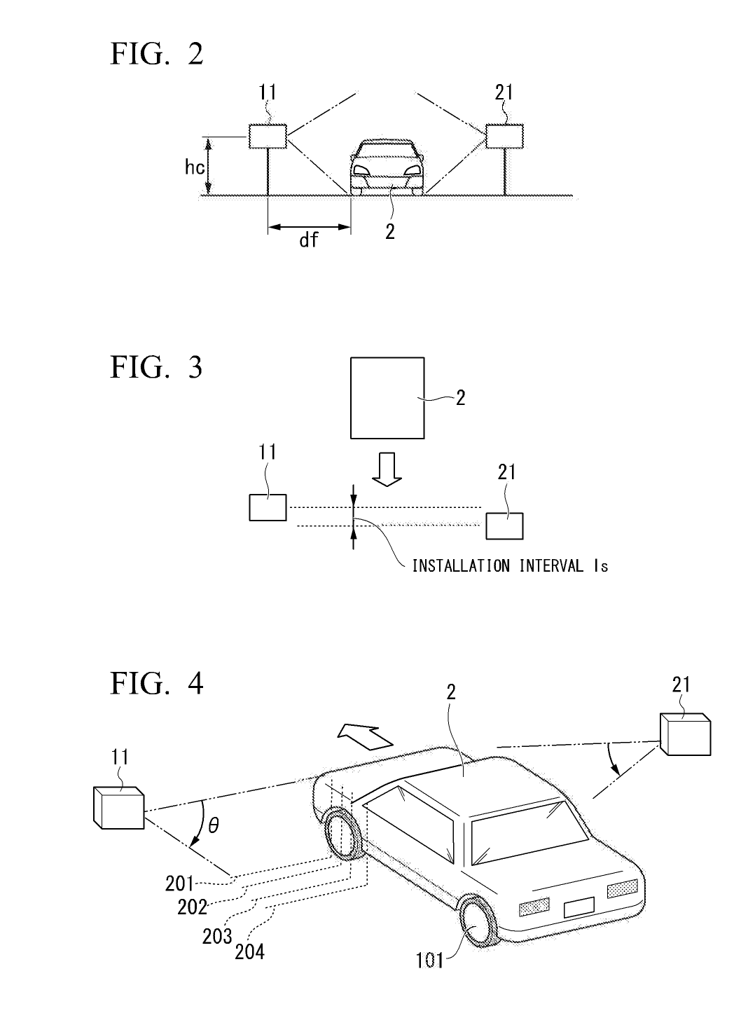

FIG. 2 is an arrangement diagram (a front view) illustrating installations of the laser scanners according to the Embodiment 1.

FIG. 3 is an arrangement diagram (a top view) illustrating installations of the laser scanners according to the Embodiment 1.

As shown in the front view in FIG. 2, the respective laser scanners 11 and 21 are installed such that they face a vehicle 2 on both sides of a path at a height hc. Assume that the distance between axes of perpendiculars from the respective laser scanners 11 and 21 to the ground face and a side face of the vehicle 2 is df.

Moreover, as shown in the top view of FIG. 3, with a gap (installation interval) ls in the traveling direction of the vehicle 2, the respective laser scanners 12 and 21 are installed.

When the two laser scanners 11 and 21 are scanning in synchronization with each other, the installation interval ls is set such that it is smaller than a diameter W of a tire of the vehicle 2 and is set such that it is longer than ½ the distance over which the vehicle 2 with a velocity of v (m/s) travels during one scan time ts (s) of the laser scanners 11 and 21. In other words, it is set as in Equation (1). The reason (v×ts) is halved in the left term of the Equation (1) is that, when the two laser scanners 11 and 21 are scanning in synchronization, sampling may be conducted at a location of half the distance of a sampling period of one side to cause the scanning resolution in the vehicle traveling direction to be substantially doubled because of the left-right symmetry of axles.

v×ts/2<ls<W (Equation (1))

For example, assuming v=80 km/h≅22.2 m/s, ts= 1/100 Hz, and W=0.6 m, the installation interval ls may be set within a range shown in Equation (2) to acquire data for which one tire may be scanned from left to right simultaneously by the two laser scanners 11 and 21.

0.11 m<ls<0.6 m (Equation (2))

In practice, it is desirable to collect as many scan data sets as possible in the vehicle travelling direction, so that the two scanners are installed with the installation interval ls thereof as v×ts/2 m, or 0.11 m at a maximum speed of 80 km/h.

On the other hand, when the two laser scanners 11 and 21 are scanning without synchronizing with each other, this installation interval ls is set such that it is smaller than the diameter W of the tire of the vehicle 2 and such that it is longer than twice a distance travelled by the vehicle 2 at a speed v (m/s) during one scan time ts (s) of the laser scanners 11 and 21. In other words, it is set as in Equation (3). The reason that (v×ts) is doubled in the left term of the Equation (3) is that the total sum of the respective sampling errors when the two laser scanners 11 and 21 are scanning without synchronizing with each other is taken into account.

2×v×ts<ls<W (Equation (3))

For example, assuming v=60 (km/h)±16.7 (m/s), ts=1/100 (Hz), and W=0.6 (m), the installation interval ls may be set within a range shown in Equation (4) to acquire data for which one tire may be scanned from left to right simultaneously by the two laser scanners 11 and 21.

0.33 (m)<ls<0.6 (m) (Equation (4))

FIG. 4 is a schematic diagram illustrating an arrangement of installations of the laser scanners 11 and 21 and exemplary scans according to the Embodiment 1.

The respective laser scanners 11 and 21 measure the distance to the vehicle 2 in one-dimensional scans.

In FIG. 4 are shown a collection of scanned points 201-204. Moreover, FIG. 4 shows the vehicle 2 having tires 101 (the letter is given to only one of the tires).

As shown in FIG. 4, the laser scanners 11 and 21 are installed alongside the vehicle 2 and measure the distance to a reflecting point of a laser light. In an example shown in FIG. 4, the laser scanner 11 conducts scanning of a laser light which is output from the laser scanner 11 on a broken line shown with 201 (or 202-204), for example, and, then, receives a scattered light (reflected light) by an obstacle and measures the distance to the obstacle based on a time difference between transmission (irradiation) of the laser light and reception of the scattered light (reflected light). The same applies also for the other laser scanner 21.

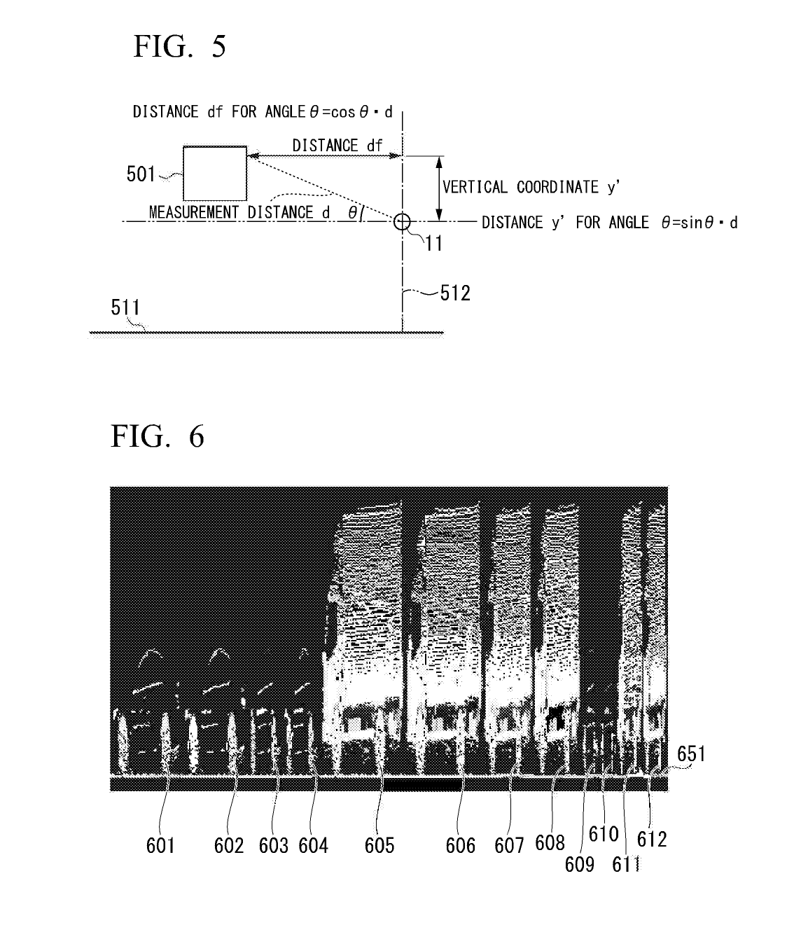

FIG. 5 is a schematic diagram illustrating the operating principles of the coordinate converters 12 and 22 according to the Embodiment 1.

According to the present Embodiment, the laser scanners 11 and 21 are structures which measure the distance while rotating, and, thus, outputs data on polar coordinates with points at which the laser scanners 11 and 21 are installed as the centers thereof.

The respective coordinate converters 12 and 22 convert data output from the respective laser scanners 11 and 21 to data on orthogonal coordinates. In an example in FIG. 5, assuming that a measurement distance to a measurement object 501 when a scan angle of the laser scanner 11 is 0 is d, in the orthogonal coordinates with the laser scanner 11 as the origin, distance data z′(=df) and a height (vertical coordinate) y′ are converted as in Equations (5) and (6). Here, θ, which is a known angle acquired at the time of scanner control, is an angle relative to a face which is parallel to a road face 511. Moreover, as shown in FIG. 5, a face including a perpendicular from the laser scanner 11 to a ground face (the road face 511) that is parallel to the measurement object 501 is set as a distance measurement standard face 512.

y′=sin θ·d (Equation (5))

y′=cos θ·d (Equation (6))

FIG. 6 is a diagram illustrating an example of measured results of distance measurement according to the Embodiment 1. FIG. 6 shows an example of distance data which are converted in the coordinate converters 12 and 22 being visualized to luminance values. In the present embodiment, in practice, the laser scanners 11 and 21 merely measure the one-dimensional distance in the vertical direction, and, in FIG. 6, an example in which a scan position of the vehicle 2 changes when the vehicle 2 passes through the front of the laser scanner 11 (and also the laser scanner 21) is shown in a visualized manner.

In FIG. 6, the horizontal axis (the horizontal direction) shows the number of scans, while the vertical axis (the vertical direction) shows the height (the height of the vehicle). In the example in FIG. 6, four sedan vehicles 601-604, four tracks 605-608, two sedan vehicles 609-610, and two tracks 611-612 pass therethrough. The higher the speed of the vehicle, the smaller the apparent horizontal width of the vehicle. For convenience of explanations, the respective sedan vehicles are set to be same and the respective track vehicles are set to be the same.

The vehicles 601-604 and 609-610 show an example in which black sedans pass therethrough. The laser light which is output from the laser scanners 11 and 21 is specularly reflected from the black body, so that the light does not return to the light receiving side of the laser scanners 11 and 21, so that there is no measured distance value.

Moreover, the vehicles 605-608 and 611-612 show an example in which the trucks pass therethrough. This example allows distance measurement on the whole face of the vehicle body.

Furthermore, the lowermost collection of data in FIG. 6 shows distance measurement data 651 for the road face 511.

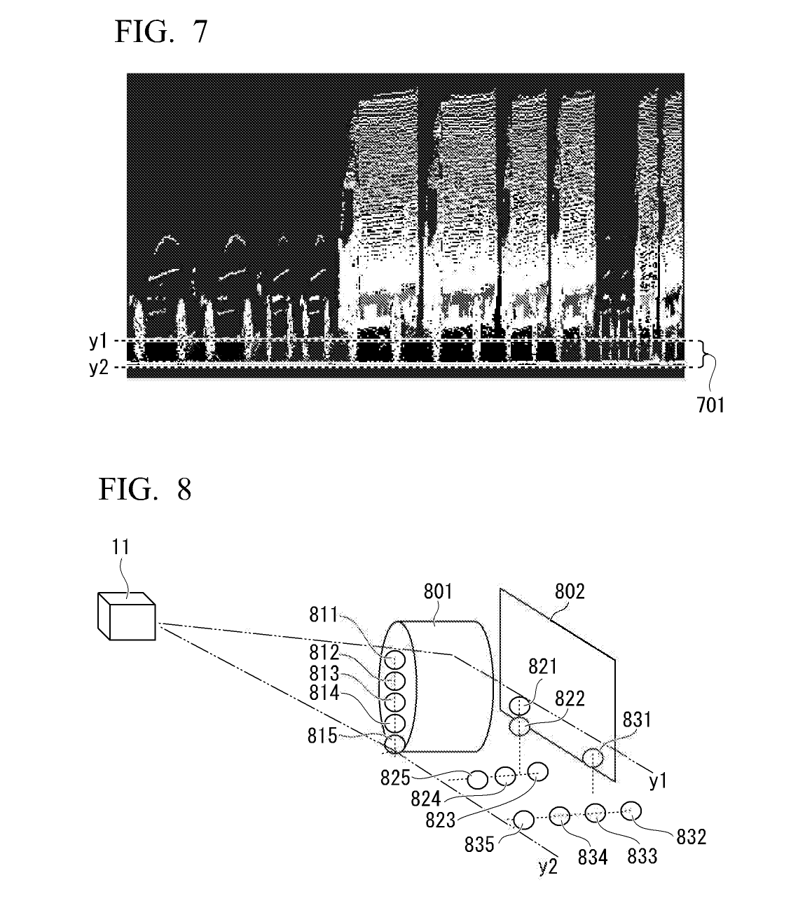

FIG. 7 is a schematic diagram illustrating a range of a region 701 specified by the measurement region setting devices 13 and 23 according to the Embodiment 1. The respective measurement region setting devices 13 and 23 set a region 701 from y1 to y2 (a height corresponding to the road face 511), which is a range of height of approximately ½ the diameter of the tire with the road face 511 as the reference, on output data from the respective coordinate converters 12 and 22. This region 701 is preferably set such that the tire region is included therein but the other structures are hardly included therein.

The respective distance histogram preparation devices 14 and 24 accumulate a data occurrence frequency by distance for a range from y1 to y2, which is a range of y′ that is specified in the respective measurement region setting devices 13 and 23.

FIG. 8 is a schematic diagram illustrating that tire and vehicle distances are measured by the laser scanner 11 (and also the laser scanner 21) according to the Embodiment 1.

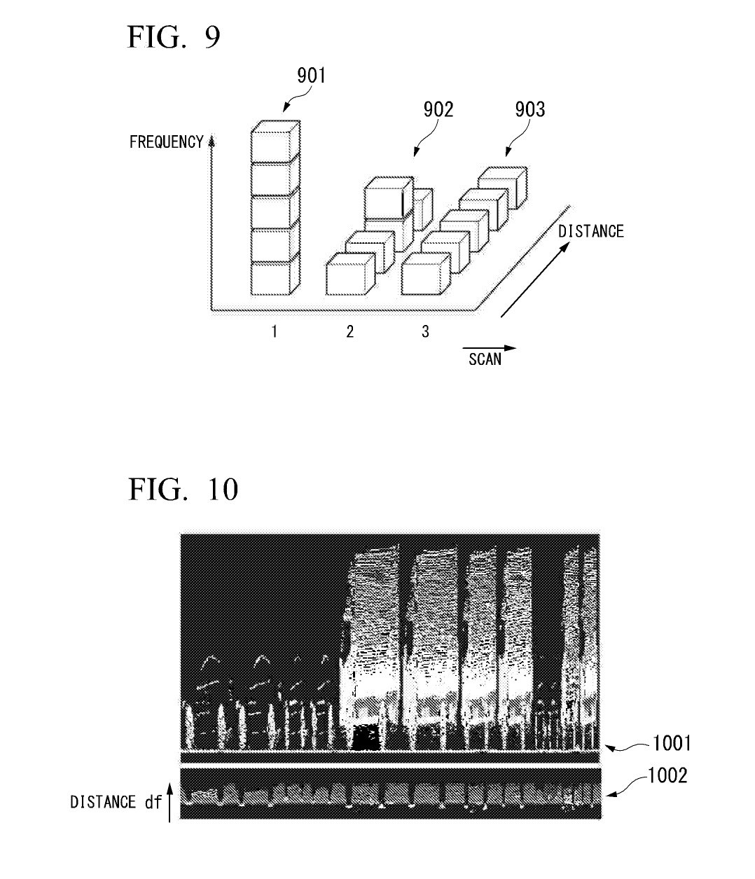

FIG. 9 is a schematic diagram illustrating a frequency distribution on results of measuring the tire and vehicle distances by the laser scanner 11 (and also the laser scanner 21) according to the Embodiment 1.

In an example in FIG. 8, scan points 811-815 in a tire region 801 and scan points 821-825 and 831-835 in a region 802 of the vehicle other than the tire are shown.

In an example in FIG. 9, frequency for each distance to scan points 811-815, 821-825, and 831-835 shown in FIG. 8 is shown. The number of scans is shown in the horizontal axis (horizontal direction), the distance is shown in the depth axis (the depth direction), and the frequency is shown in the vertical axis (the vertical direction).

In the example in FIG. 9, the frequency of data occurrence characteristic 901 when the tire region 801 of the vehicle is scanned is high where there is a correspondence to the tire distance. On the other hand, the frequency of data occurrence characteristics 902 and 903 when the region 802 of the vehicle other than the tire is scanned is low where there is a correspondence to the tire distance.

FIG. 10 is a diagram illustrating the operating principles of the distance histogram preparation devices 14 and 24 according to the Embodiment 1.

In FIG. 10 is shown an example in which a frequency distribution (histogram) 1002 for each distance is prepared for the distance data 1001 shown in FIG. 7. In this frequency distribution 1002, the horizontal axis (horizontal direction) shows the number of scans, the vertical axis (vertical direction) shows a distance df, and the frequency is shown with a chrominance value. In the distance data 1001 and the frequency distribution 1002, the smaller distance is shown brighter (in white), while the larger distance is shown darker (in black).

In the frequency distribution 1002 shown in FIG. 10, it is seen that data with the high chrominance value and a large frequency are concentrated in accordance with the tire location.

The respective tire candidate extractors 15 and 25 extract data whose frequency is higher than a predetermined threshold value from frequency distribution data (frequency data) which are output from the respective distance histogram preparation devices 14 and 24 as tire candidate data to detect the extracted data. In this case, the respective tire candidate extractors 15 and 25 may be configured to extract only data for which the distance is less than or equal to a predetermined threshold as the tire candidate data.

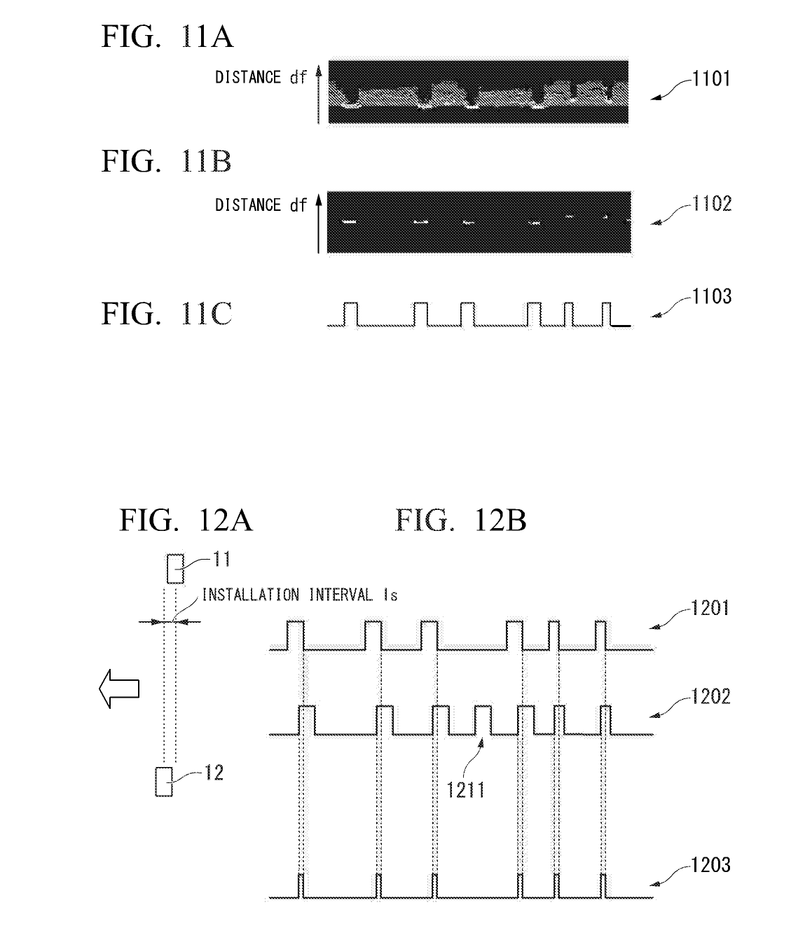

FIGS. 11A-11C are schematic diagrams illustrating the operating principles of the tire candidate extractors 15 and 25 according to the Embodiment 1.

FIG. 11A shows a frequency distribution 1101, which shows the same data as the frequency distribution 1002 shown in FIG. 10. FIGS. 11A, 11B, and 11C show the first three vehicles shown in FIG. 10.

FIG. 11B shows results (extracted data 1102) of extracting data with the frequency which is greater than equal to a certain value (predetermined threshold value) with respect to the frequency distribution 1101 shown in FIG. 11A.

FIG. 11C shows a concatenation of the extracted data 1102 shown in FIG. 11B that is set as time-series binary data (binary data 1103). The respective tire candidate extractor 15 and 25 output the binary data 1103 as the tire candidate data.

The left right matching processor 31 matches left and right tire candidate data sets which are output from the two tire candidate extractors 15 and 25 to remove external disturbance factors.

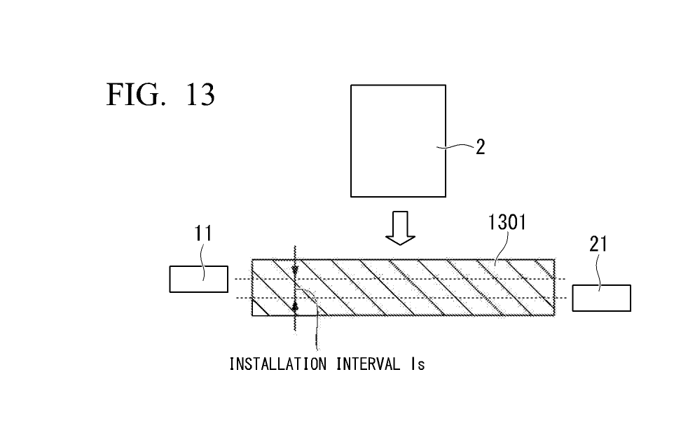

FIGS. 12A and 12B are schematic diagrams illustrating the operating principles of the left right matching processor 31 according to the Embodiment 1.

FIG. 12A shows an arrangement of the two laser scanners 11 and 21.

FIG. 12B shows a signal (a tire candidate signal 1201) which applies to tire candidate data which are output from the tire candidate extractor 15 on one side (for example, the right side); a signal (a tire candidate signal 1202) which applies to tire candidate data which are output from the tire candidate extractor 25 on the other side (for example, the left side); and results data (left right matching results 1203) in which these left and right tire candidate data sets are matched to remove external disturbance data 1211.

In an example shown in FIG. 12B, the left right matching processor 31 determines the characteristic (the simultaneous appearance property) that tire candidates appear simultaneously from a result output (the tire candidate signal 1201) in which a tire candidate is extracted from a signal output by the laser scanner 11 and a result output (the tire candidate signal 1202) in which a tire candidate is extracted from a signal output by the laser scanner 21 to output a left right matching result 1203 in which only tire candidates having the simultaneous appearance property in the left and the right are kept.

Moreover, the left right matching processor 31 also outputs left right tire candidate signals 1202 and 1203.

Here, in the present embodiment, the two laser scanners 11 and 21 are installed with an offset by the installation interval ls, which is set smaller than the diameter of the tire, so that there is a case in which an axle candidate is output from both the output from the laser scanner 11 and the output of the laser scanner 12. In an example in FIG. 12, as an example, a logical product of the two tire candidate signals 1201 and 1202 is determined to output the determined result as the left right matching result 1203. In this way, an effect of the external disturbance data 1211 which only occurs with the scanner on the one side (for example, the laser scanner 21) may be reduced (for example, removed). In this way, for example, even if a gasoline tank or modified mufflers is detected by a scanner data set in either one direction (a scanner data set by the laser scanner 11 or a scanner data set by the laser scanner 21), such external disturbance data 1211 may be removed by a left right matching process.

As another configuration example, the left right matching processor 31 may be configured to match left and right tire candidate data sets which are output from the two tire candidate extractors 15 and 25 at a time offset within a range which is predetermined, taking into account the installation interval ls, etc.

Based on the left and right tire candidate signals 1202 and 1203 which are output from the left right matching processor 31, the tire advancing/reversing determination device 32 identifies advancing and reversing. The tire advancing/reversing determination device 32 outputs the result of identification of the advancing and the reversing and the left right matching result 1203 which is output from the left right matching processor 31.

In the example in FIG. 12A, when the vehicle 2 advances, the laser scanner 11 captures the tire of the vehicle 2 earlier, so that the tire candidate signal 1201 appears earlier. On the other hand, when the vehicle 12 reverses, the laser scanner 21 captures the tire of the vehicle 2 earlier, so that the tire candidate signal 1202 appears earlier. In this way, the tire advancing/reversing determination device 32 determines whether to pass therethrough while advancing or while reversing for each one respective tire.

Based on the output signal from the tire advancing/reversing determination device 32, the axle-number counting device 33 counts the tire candidates which were determined to have the simultaneous appearance property by matching in the left and right matching processor 31 in units of each vehicle and outputs the counted result (information on the number of axles). In this case, the axle-number counting device 33 detects the axles for the tire candidate which is assumed to be the tire.

Here, according to the present embodiment, as the value of the counting, the axle-number counting device 33 outputs a difference (an absolute value, for example) between the number of advancing and the number of reversing. As a specific example, when, after one “tire advancing”, one “tire reversing” occurs and a further one “tire advancing” occurs, the axle number calculation device 33 outputs the counted number of axles as “1” (=+1−1+1). In this way, in a congestion, etc., for example, correct counting may be made even in a special case such that the tire of the vehicle 2 reverses in the middle of advancing in front of the laser scanners 11 and 21.

As described above, the axle detection apparatus 1 according to the present embodiment may accurately detect the axle of the vehicle 2 (or detection of the tire, which is substantially the same therewith) based on data on distance measurement by the laser scanners 11 and 21.

In the axle detection apparatus 1 according to the present embodiment, multiple distance measurement devices (the laser scanners 11 and 21 in the present embodiment) changes a measurement range to one dimension to measure distance data; the tire candidate extractors 15 and 25 extracts data whose frequency is higher than a predetermined threshold as data on tire candidates based on data on a distance calculated by the distance measurement device; a matching processor (the left right matching processor 31) matches a temporal correspondence on the data on the tire candidates extracted by the tire candidate extractors 15 and 25 based on the respective data sets on the distance measured by the multiple distance measurement devices; and an axle detector (the axle-number counting device 33 in the present embodiment) detects the axle based on the matched result by the matching processor. In the axle detection apparatus 1 according to the present embodiment, the axle detector counts the number of axles detected. In the axle detection apparatus 1 according to the present embodiment, the tire advancing/reversing determination device 32 determines advancing or reversing of the tire with a temporal offset for data on tire candidates extracted by the tire candidate extractors 15 and 25 based on the respective data sets on the distance measured by multiple distance measurement devices, and the axle detector detects an axle based on the matched result by the matching processor and the determined result by the tire advancing/reversing determination device 32.

As a specific example, the axle detection apparatus 1 according to the present embodiment includes at least two distance measurement devices (laser scanners 11 and 21 in the present embodiment) which can change the measurement range to one dimension and performs the process as follows:

The coordinate converters 12 and 22 perform coordinate conversion of measurement data which are output by the distance measurement device. The measurement region setting devices 13 and 23 restrict the region to the height direction of data output by the coordinate converters 12 and 22. The distance histogram preparation devices 14 and 24 determine the frequency of distance data restricted by the measurement region setting devices 13 and 23. Using results by the distance histogram preparation devices 14 and 24, the tire candidate extractors 15 and 25 extract data on a region whose frequency is high that corresponds to the tire. The left right matching processor 31 determines a temporal correspondence on data output from the tire candidate extractor 25 in correspondence with data output from multiple distance measurement devices. The tire advancing/reversing determination device 32 determines a temporal offset on the data output from the tire candidate extractor 25 in correspondence with the data output from the multiple distance measurement devices. The axle-number counting device 33 tabulates data output from the tire advancing/reversing determination device 32 to count the number of axles of the vehicle 2 (the number of axles).

Various numbers may be used as the number of multiple distance measurement devices.

Moreover, in the axle detection apparatus 1 according to the present embodiment, multiple distance measurement devices are installed with an interval therebetween being set to be shorter than the diameter of the tire to be measured.

Furthermore, in the axle detection apparatus 1 according to the present embodiment, the coordinate converters 12 and 22 convert polar coordinate data to orthogonal coordinate data and convert data on the road face 511 to information in which all heights are the same.

Moreover, in the axle detection apparatus 1 according to the present embodiment, the measurement region setting devices 13 and 23 set the range of height to be shorter than the diameter of the tire to be measured.

Furthermore, in the axle detection apparatus 1 according to the present embodiment, the left right matching processor 31 determines a logical product of results output from the multiple tire candidate extractors 15 and 25.

As described above, the axle detection apparatus 1 according to the present embodiment may eliminate external disturbances by objects other than the tire, such as a gasoline tank, modified mufflers, etc., of the truck and realize a highly accurate axle detection.

Moreover, the axle detection apparatus 1 according to the present embodiment may match extracted results of multiple distance measurement devices (the two laser scanners 11 and 21 in the present embodiment) even when the number of data sets which may be collected is low, such as 1 scan to 2 scans for the tire with respect to the vehicle 2 whose traveling speed is high to stably detect the axle. In this way, for example, low-speed distance measurement devices (the laser scanners 11 and 21 according to the present embodiment) may be used to detect the axle of the vehicle 2, which passes therethrough at high speed.

More specifically, with the laser scanners 11 and 21 which scan vertically with respect to the traveling direction of the vehicle 2 from the side face of the vehicle 2, for example, the number of data sets which may be collected is low, such as 1 scan to 2 scans for the tire with respect to the vehicle whose traveling speed is high at a hourly speed of approximately 80 km/h with a scan speed of between 50 Hz and approximately 100 Hz. Even in such a case, the present embodiment may improve the reliability of axle detection.

Moreover, in the axle detection apparatus 1 according to the present embodiment, distance measurement devices (laser scanners 11 and 21 in the present embodiment) may be installed at an interval which is smaller than the diameter of the tire to determine advancing or reversing in units of tires and accurate advancing/reversing determination may be made.

Furthermore, in the axle detection apparatus 1 according to the present embodiment, when the laser scanners 11 and 21 are used, frequency of distance data on a tire from which a laser light is stably reflected may be counted to stably detect an axle even in an environment such that, for example, a water puddle is produced on a road and a laser light is specularly reflected therefrom to cause an irradiated light to not return to the laser scanners 11 and 21, so that the distance may not be measured normally.

Moreover, the axle detection apparatus 1 according to the present embodiment may output a tire candidate for each one scan to instantly output an axle detection result after passing therethrough of the tire since the tire candidate is output for each one scan.

### Second Embodiment

Below, the axle detection apparatus 1 according to Embodiment 2 is described with reference to the drawings.

A configuration of the axle detection apparatus 1 according to the present embodiment is generally the same as that according to the Embodiment 1. Below, points which are different from the Embodiment 1 are described in detail and detailed explanations are omitted for points which are the same as the Embodiment 1.

FIG. 13 is a diagram (top view) illustrating a reference plate 1301 which is laid on a road according to the Embodiment 2.

According to the present embodiment, as shown in FIG. 13, the reference plate 1301 is laid on the road with respect to a range through which scan lights of the two laser scanners 11 and 21 pass. As an example of a configuration in which the reference plate 1301 is laid on the road, the reference plate 1301 may be buried on the road surface (road face). Other configurations and operations are generally the same as those for the Embodiment 1.

Here, while a road face is normally laid with concrete or asphalt, the reference plate 1301 according to the present embodiment is made of materials in which water is unlikely to be accumulated and with a large number of laser diffuse reflection components, such as rubber, a special asphalt with a large number of gaps, etc. In this way, in the present embodiment, even at the time of rain, dropping of distance measurement data due to specular reflection from a road surface or water splash by the tire of the vehicle may be prevented and the axle may be accurately detected based on the distance measurement data by the laser scanners 11 and 21.

As the material, the shape, the size, etc., of the reference plate 1301, various ones may be used. For example, the shape and the size of the reference plate 1301 may be set such that the reference plate 1301 includes the scan range of the laser of the two laser scanners 11 and 21.

The axle detection apparatus 1 according to the present embodiment includes a reflective material (the reference plate 1301 according to the present embodiment) which is installed at the locations in accordance with the multiple distance measurement devices (laser scanners 11 and 21 according to the present embodiment) to be made of the material having the quality that is different from that of the road face 511 to be provided on the road.

As a specific example, the axle detection apparatus 1 according to the present embodiment, in the configuration which is similar to the Embodiment 1, further includes a reflective material (the reference plate 1301 according to the present embodiment) which is installed at the locations of the distance measurement devices (laser scanners 11 and 21 according to the present embodiment) to be made of the material having the quality that is different from that of the road face 511 to be buried in the road, etc.

As described above, in the axle detection apparatus 1 according to the present embodiment, producing of water puddles on the road is prevented and, moreover, the road distance may be accurately measured to accurately realize axle detection even at the time of rain.

### Third Embodiment

Below, the axle detection apparatus 1401 according to Embodiment 3 is described with reference to the drawings.

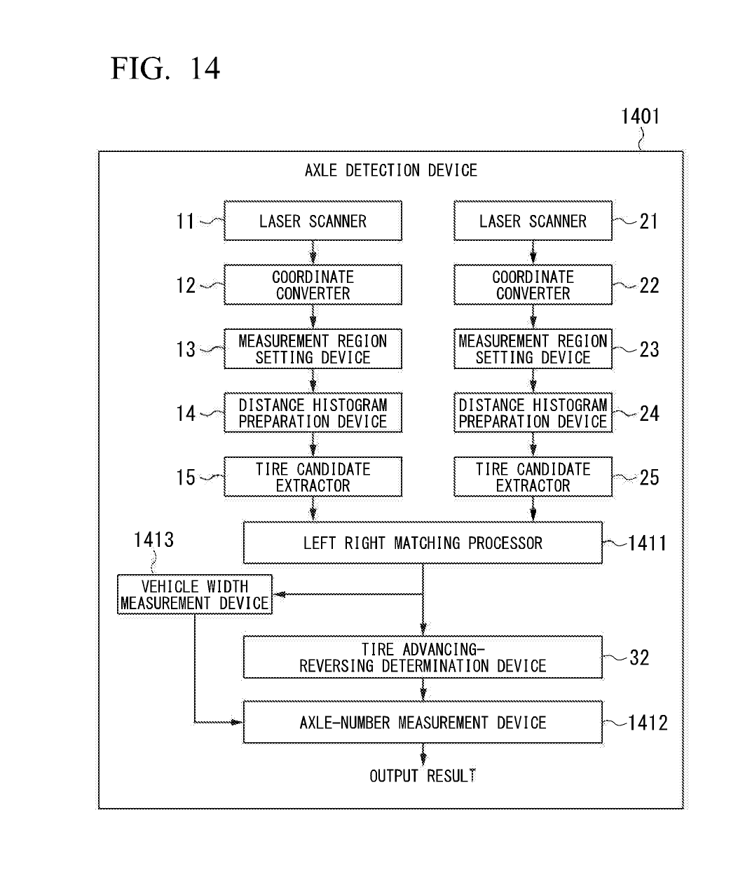

FIG. 14 is a block diagram illustrating a configuration of the axle detection apparatus 1401 according to the Embodiment 3.

The axle detection apparatus 1401 includes two laser scanners 11 and 21; two coordinate converters 12 and 22; two measurement region setting devices 13 and 23; two distance histogram preparation devices 14 and 24; two tire candidate extractors 15 and 25; one left right matching processor 1411; one tire advancing/reversing determination device 32; one axle-number counting device 1412; and one vehicle width measurement device 1413.

Here, in the present embodiment (FIG. 14), the same letters are given for the same processor as the processor shown in the Embodiment 1 (FIG. 1).

In comparison to the configuration shown in FIG. 1, in the axle detection apparatus 1401 according to the present embodiment, the vehicle width measurement device 1413 is included therein and, regarding the point that the vehicle width measurement device 1413 is included therein, the left right matching processor 1411 and the axle-number counting device 1412 perform additional processes.

Below, points which are different from the Embodiment 1 are explained in detail and detailed explanations on the same points as those for the Embodiments are omitted.

An output signal from the left right matching processor 1411 is input to the tire advancing/reversing determination device 32 and input to the vehicle width measurement device 1413. Here, information which allows grasping of the tire candidate distance is included in a signal input into the vehicle width measurement device 1413 from the left right matching processor 1411.

The vehicle width measurement device 1413 measures the vehicle width from the left and right distances with respect to the tire candidate which is collated by the left right matching processor 1411 to determine the measure result to output information related thereto. More specifically, the vehicle width measurement device 1413 performs a calculation (estimated calculation suffices) of the vehicle width of the vehicle 2 with predetermined calculation equations, etc., from the distance of the left side tire and the right side tire of the vehicle 2. Here, the vehicle width is normally greater or equal to 1 m for a four-wheeled vehicle, while it is at most several tens of centimeters for a two-wheeled vehicle. For example, the vehicle width measurement device 1413 determines that the vehicle is a four-wheeled vehicle (or a vehicle having more axles) when the determined vehicle width exceeds a predetermined threshold, while it is a two-wheeled vehicle when the determined vehicle width is less than or equal to the predetermined threshold, and outputs information indicating the determined results (information indicating the types).

In addition to the operation shown in the Embodiment 1, based on an output from the vehicle width measurement device 1413, the axle-number counting device 1412 outputs information which allows distinguishing between the four-wheeled vehicle (or a vehicle with further more axles) and the two-wheeled vehicle. More specifically, for example, when the vehicle is a two-wheeled vehicle, the axle-number counting device 1412 outputs the number of axles as information called “advancing 2” (, which is one example and may be arbitrary).

Here, with the two-wheeled vehicle, a large number of fixtures are attached to a portion under the vehicle and the driver may stick his foot therefrom, so that measurement of articles installed on the road surface by the laser scanners 11 and 21 do not stabilize. As in the present embodiment, information on the counting results may be replaced in accordance with the vehicle width (the vehicle width of the four-wheeled vehicle (or the vehicle with even more axles)/the vehicle width of the two-wheeled vehicle in the present embodiment) to eliminate the effect of the external disturbance.

In the axle detection apparatus 1401 according to the present embodiment, the vehicle width measurement device 1413 measures the width of the vehicle based on matched results by the matching processor (the left right matching processor 1411 in the present embodiment) and sets the number of axles to be 2, which corresponds to the two-wheeled vehicle, when the measured vehicle width is less than or equal to a predetermined threshold based on results of measurement by the vehicle width measurement device 1413.

As a specific example, in the axle detection apparatus 1401 according to the present embodiment, in the similar configuration to the Embodiment 1 (, which may also be the Embodiment 2), and, furthermore, based on the left right matching results output from the left right matching processor 1411, the vehicle width measurement device 1413 determines the width of the vehicle. Moreover, the axle-number counting device 1412 tabulates data output from the vehicle width measurement device 1413 and data output from the tire advancing/reversing determination device 32 to calculate the number of vehicle axles. For example, the axle-number counting device 1412 changes the number of axles to 2 when the vehicle width obtained by the vehicle width measurement device 1413 is less than or equal to a certain value.

As described above, even when there is an external disturbance such as a foot of a driver and the vehicle width cannot be measured for the two-wheeled vehicle, the axle detection apparatus 1401 may handle the two-wheeled vehicle as an exception to perform an accurate axle detection.

The axle detection apparatus 1 (or the axle detection apparatus 1401) according to at least one embodiment as described above may include a matching processor which matches a temporal correspondence for tire candidate data extracted by the tire candidate extractors 15 and 25 based on the respective distance data sets measured by multiple distance measurement devices to reduce erroneous detection, making it possible to accurately perform a detection of an axle based on data on distance measurement by the laser scanners 11, 21, etc., for example.

Programs for realizing functions of respective apparatuses (for example, the axle detection apparatus 1, the axle detection apparatus 1401) according to the embodiments described above may be recorded in a computer-readable recording medium to read the programs recorded in the recording medium into a computer system and execute the recorded programs to perform the process.

The “computer system” herein may include an operating system (OS) and hardware such as peripheral equipment, etc.

Moreover, the “computer-readable recording medium” refers to a storage apparatus such as a flexible disk, a magneto-optical disk, a ROM (read only memory), a writable non-volatile memory such as a flash memory, etc., a portable medium such as a DVD (digital versatile disk), etc., a hard disk embedded in a computer system.

Furthermore, the “computer-readable recording medium” may also include those which hold programs for a certain time, such as a volatile memory (for example, a DRAM (dynamic random access memory)) within a computer system to be a server or a client when programs are transmitted via communications lines such as a telephone line, etc., a network such as the Internet, etc.

Moreover, the above-described programs may be transmitted from a computer system having these programs stored in the storage apparatus, etc., to a different computer system via a transmission medium, or a transmission wave in the transmission medium. Here, the “transmission medium” which transmits the programs refers to a medium which includes the function of transmitting information, such as a network (communications network) including the Internet, etc., and a communications circuit (communications line) including a telephone circuit, etc.

The above-described programs may be those for realizing a part of the above-described function. Moreover, the above-described programs may be those which may realize the above-described function in a combination with programs which are already recorded in the computer system, or a so-called differential files (differential programs).

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1. An axle detection apparatus, comprising:
a plurality of distance measurement devices, each of which changes a measurement range to one dimension to measure a distance data set;
a tire candidate extractor which extracts data whose frequency is higher than a predetermined threshold as tire candidate data based on the distance data set measured by the distance measurement device;
a matching processor which matches a temporal correspondence for the tire candidate data which are extracted by the tire candidate extractor based on the respective distance data sets measured by the plurality of distance measurement devices; and
an axle detector which detects one or a plurality of axles based on the matched result by the matching processor.

2. The axle detection apparatus as claimed in claim 1, wherein the axle detector counts the number of axles detected.

3. The axle detection apparatus as claimed in claim 1, further comprising:
a tire advancing/reversing determination device which determines advancing or reversing of a tire by a temporal offset for the tire candidate data extracted by the tire candidate extractor based on the respective distance data sets measured by the plurality of distance measurement devices,
wherein the axle detector detects the one or the plurality of axles based on the matched result by the matching processor and the determined result by the tire advancing/reversing determination device.

4. The axle detection apparatus as claimed in claim 1, further comprising:
a reflective material which is installed at a position in accordance with the plurality of distance measurement devices to be made of the quality of material that is different from that of a face of a road to be provided on the road.

5. The axle detection apparatus as claimed in claim 1, further comprising:
a vehicle width measurement device which measures a width of a vehicle based on the matched result by the matching processor, and
wherein the axle detector sets the number of axles to two, which corresponds to a two-wheeled vehicle when the measured width of the vehicle is less than or equal to a predetermined threshold based on the measured result by the vehicle width measurement device.
